(19) United States
(12) Patent Application Publication
(10) Pub. No.: US 2026/0159624 A1
(43) Pub. Date: Jun. 11, 2026

(54) OXIDIZED LIGNIN POLYCARBOXYLATE SALT, PREPARATION METHOD, AND USE AS A WATER REDUCER

(71) Applicant: JIAHUA SCIENCE & TECHNOLOGY DEVELOPMENT (SHANGHAI) LTD., Shanghai (CN)

(72) Inventors: Xiao LU, Shanghai (CN); Xinyao HE, Shanghai (CN); Yubo LI, Shanghai (CN)

(73) Assignee: JIAHUA SCIENCE & TECHNOLOGY DEVELOPMENT (SHANGHAI) LTD., Shanghai (CN)

(21) Appl. No.: 18/681,738

(22) PCT Filed: Oct. 30, 2023
(86) PCT No.: PCT/CN2023/127576

§ 371 Date: Feb. 6, 2024

(30) Foreign Application Priority Data
Oct. 11, 2023 (CN) 202311316537.4

(51) Int. Cl. C08F 283/06; C04B 24/26; C04B 103/30

(52) U.S. Cl. CPC C08F 283/065; C04B 24/2694; C04B 2103/302

(57) ABSTRACT

The present application belongs to the technical field of functional additives for concrete materials, in particular relates to an oxidized lignin polycarboxylate salt, and further discloses its use for preparing high-efficiency water reducer. The method for preparing oxidized lignin polycarboxylate salt as described in the present application involves oxidizing and modifying lignin under alkaline conditions, and polymerizing oxidized lignin, carboxylic acid based small monomers and alkenyl polyethylene glycol ether as monomers to obtain oxidized lignin polycarboxylate salt that can be used as an high-efficiency water reducer. The oxidized lignin polycarboxylate water reducer described in the present application, compared with traditional polycarboxylate based water reducer, replaces all or part of traditional carboxylic acid based small monomers with lignin based carboxylic acid monomers, which not only reduces the cost of polycarboxylate water reducer but also improves their slump retention ability, and has significant cost-effectiveness and environmental protection benefits.

### CROSS REFERENCE TO RELATED APPLICATIONS

The present application claims priority to Chinese Patent Application No. 2023113165374, entitled “Oxidized lignin polycarboxylate salt, preparation method, and use as a water reducer”, and filed to the China National Intellectual Property Administration on Oct. 11, 2023, the entire contents of which are incorporated herein by reference.

### TECHNICAL FIELD

The present application belongs to the technical field of functional additives for concrete materials, in particular relates to an oxidized lignin polycarboxylate salt, and further discloses its use for preparing high-efficiency water reducer.

### BACKGROUND

Concrete, as the largest building material in the world, is widely used in various large-scale infrastructure constructions for cities, transportation, water conservancy, etc., and can be regarded as the cornerstone of modern social civilization. As an essential component of high-quality concrete, admixtures are receiving increasing attention.

As the most commonly used concrete admixture, water reducer greatly enhance the performance of concrete. On the one hand, water reducer can adsorb on the surface of cement particles and disrupt the flocculation and agglomeration among particles through electrostatic repulsion or steric hindrance, thereby dispersing the cement particles and releasing the water enclosed by the flocculation structure, thereby endowing concrete with better fluidity. On the other hand, the addition of water reducer can form an adsorption film on the surface of cement particles, affecting the hydration rate of cement, making the growth of cement stone crystals more complete, reducing the capillary pores of water evaporation, and making the network structure more dense, thereby endowing concrete with higher strength and durability.

At present, the widely used concrete water reducers mainly comprise lignin sulfonate salt water reducer, naphthalene based water reducer, melamine based water reducer, amino sulfonic acid based water reducer, aliphatic based water reducer, and polycarboxylate based water reducer. Among them, polycarboxylate based water reducer, as the third-generation water reducer, has occupied an absolute market advantage due to its advantages of simple process, easy structure adjustment, excellent performance, etc. However, as a typical petroleum based chemical synthetic polymer, polycarboxylate water reducers face increasing environmental and cost pressures. The green and low-carbon production of traditional water reducers has become an inevitable challenge and opportunity for technological innovation in the water reducer industry. Lignin based water reducers (such as lignosulfonate, oxidized lignin, etc.) are mainly made from renewable lignin as the main raw material. Although they have significant cost and environmental advantages, their application performance is not ideal, and there are generally problems such as low water reduction rate, high air entrainment, and severe delayed coagulation, which greatly limit their application range.

For example, Chinese patent CN102504138A provides a process for oxidizing lignin under acidic conditions and then grafting vinyl macromonomers and acrylic acid to prepare efficient water reducers. However, under acidic conditions, alkaline lignin, sulfate lignin, and organic solvent lignin are not soluble, which increases the difficulty of the next step of oxidation modification. At the same time, carboxylic acid based vinyl monomers are indispensable components in this application. As an another example, Chinese patent CN102504272A provides a method for preparing modified lignin sulfonate salt water reducer, but the lignin raw materials of this process are only limited to lignin sulfonate salts. At the same time, after oxidation, lignin sulfonate salts need to react sequentially with acrylic acid, maleic acid, and polyethylene glycol, making the modification steps cumbersome and time-consuming. Meanwhile, polyethylene glycol can only be partially grafted onto lignin by reacting with the active hydroxyl groups in the lignin structure.

Therefore, in this field, it is expected to combine the economic benefits and environmental protection effects of lignin with the high-performance of polycarboxylate water reducer, which not only opens up a direction for the high-value application of lignin, but also finds more valuable solutions for the green and low-carbon production of polycarboxylate based products.

### SUMMARY OF THE INVENTION

Therefore, the technical problem to be solved by the present application is to provide an oxidized lignin polycarboxylate salt, which has the performance advantages of low cost, green and low carbonization production.

The second technical problem to be solved by the present application is to provide a method for preparing the above-mentioned oxidized lignin polycarboxylate salt. The method comprises oxidizing lignin under alkaline conditions, introducing carboxylic acids with double bonds into the lignin structure, endowing lignin with hydrophilicity and polymerization activity; and then, copolymerizing the oxidized lignin, carboxylic acid based small molecules which is partially or completely replaced by oxidized lignin and unsaturated polyethylene glycol ether to prepare a low-cost polycarboxylate water reducer with unique properties.

The third technical problem to be solved by the present application is to provide use of the above-mentioned oxidized lignin polycarboxylate salt for preparing high-efficiency water reducer.

To solve the above-mentioned technical problems, the method for preparing oxidized lignin polycarboxylate salt described in the present application comprises the following steps:

(1) adding a lignin into an alkaline solution system to prepare a lignin solution, and adding an oxidant to carry out an oxidation modification treatment and introduce carboxyl group to the lignin to obtain a solution containing oxidized lignin;
the oxidation principle of lignin under alkaline conditions is as follows:

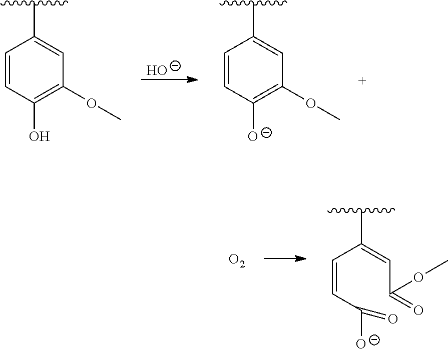

(2) using the oxidized lignin, a carboxylic acid based small monomer, and an alkenyl polyethylene glycol ether as co-monomers, and adding an initiator for free radical copolymerization reaction in a solution system to obtain the desired oxidized lignin polycarboxylate salt:

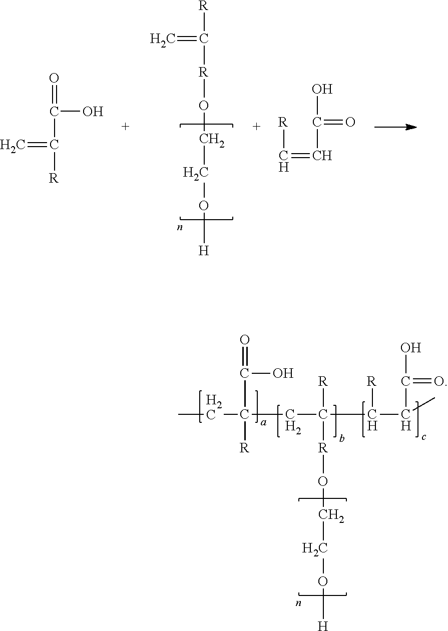

Specifically, in step (1), the lignin comprises one of or a mixture of more of alkali lignin, sulfate lignin, lignin sulfonate salt and organic solvent lignin;

Specifically, the solid mass of the lignin accounts for 5 wt % to 15 wt % of the total amount of the alkaline solution.

Specifically, in step (1), the amount of the alkaline substance in the alkaline solution accounts for 10 wt % to 60 wt % of the solid mass of the lignin.

Specifically, in step (1), the alkaline substance in the alkaline solution comprises one of or a mixture of more of alkali metal or alkali earth metal hydroxides, and alkali metal or alkali earth metal salts, for example, one of or a mixture of sodium hydroxide, potassium hydroxide, sodium carbonate and potassium carbonate.

Specifically, in step (1), the oxidant comprises one of or a mixture of more of peroxides, molecular oxygen, air or ozone;

Specifically, in step (1), the amount of the oxidant added is 20 wt % to 80 wt % of the solid mass of the lignin.

Specifically, in step (1), the oxidation modification treatment step is carried out at a temperature ranging from 30° C. to 100° C. for a reaction time period ranging from 10 minutes to 120 minutes.

Specifically, in step (2), the mass ratio of the oxidized lignin, the carboxylic acid based small monomer, and the alkenyl polyethylene glycol ether is 1:(0-20):(0-200).

Specifically, in step (2), the carboxylic acid based small monomer comprise one of or a mixture of more of acrylic acid, methacrylic acid, maleic acid, or itaconic acid;

Specifically, in step (2), the alkenyl polyethylene glycol ether comprises one of or a mixture of more of allyl polyethylene glycol ether, methylallyl polyethylene glycol ether, isopentenyl polyethylene glycol ether, vinyl polyethylene glycol ether, and 4-hydroxybutyl vinyl polyethylene glycol ether. Optionally, the molecular weight of the alkenyl polyethylene glycol ether is in a range from 500 to 6000.

Specifically, in step (2), the initiator comprises a persulfate salt and a water-soluble azo initiator, such as sodium persulfate, potassium persulfate, ammonium persulfate, and azodiisobutylamidine hydrochloride.

Specifically, in step (2), the amount of the initiator added accounts for 0.05 wt % to 10 wt % of the total mass of the monomers.

Specifically, in step (2), the free radical copolymerization reaction is carried out at a temperature ranging from 50° C. to 100° C.

Specifically, in the preparation method described in the present application, as an applicable embodiment, in step (2), the mode for feeding respective raw materials comprises:
carrying out a polymerization reaction directly based on the solution system containing the oxidized lignin obtained in step (1) as the basic material, adding the initiator directly into the basic material, and adding a carboxylic acid based small monomer and alkenyl polyethylene glycol ether monomer to carry out a copolymerization reaction directly; or,
adding the solution containing the oxidized lignin, an alkenyl polyethylene glycol ether, and an initiator into the basic material, and preparing and forming a solution from the carboxylic acid based small monomer and dropping the solution into the reaction vessel; preferably, controlling the dropping time of the solution of the carboxylic acid based small monomer to be 2 hours to 4 hours; or,
adding the alkenyl polyethylene glycol ether and the initiator into the basic material, and mixing the solution containing the oxidized lignin with the carboxylic acid based small monomer to prepare a solution and dropping the solution into the reaction vessel for reaction; preferably, controlling the dropping time of the solution containing the carboxylic acid based small monomer-oxidized lignin to be 2 hours to 4 hours; or,
adding the initiator into the basic material directly, mixing the solution containing the oxidized lignin with the carboxylic acid based small monomer to prepare a solution, and preparing and forming a solution from the alkenyl polyethylene glycol ether, and dropping them respectively into the reaction vessel for reaction; preferably, controlling the dropping time of the solution containing the carboxylic acid based small monomer-oxidized lignin to be 2 hours to 4 hours, and the dropping time for the solution of the alkenyl polyethylene glycol ether to be 2.5 hours to 4.5 hours.

The present application also discloses the oxidized lignin polycarboxylate salt prepared and obtained by the method.

The present application also discloses use of the oxidized lignin polycarboxylate salt for preparing high-efficiency water reducer, especially for concrete material systems.

The method for preparing oxidized lignin polycarboxylate salt as described in the present application involves oxidizing and modifying lignin under alkaline conditions, and using the oxidized lignin, the carboxylic acid based small monomers and alkenyl polyethylene glycol ether as monomers to perform polymerization to prepare and obtain the oxidized lignin polycarboxylate salt that can be used as an high efficient water reducer.

The oxidized lignin polycarboxylate salt water reducer described in the present application, relative to traditional polycarboxylate based water reducer, has improved environmental protection benefits while reducing costs due to the introduction of lignin based carboxylic acid based small monomer. Compared with traditional lignin based water reducer, the introduction of polyethylene ether side chains and carboxylic acid based small monomers significantly improves their performance. Not only the water reducing performance is comparable to that of the conventional polycarboxylate water reducer, but also the slump retention ability is more excellent. At the same time, both air entrainment and delayed coagulation are significantly reduced. The application performance of the oxidized lignin polycarboxylate salt high-efficiency water reducer described in the present application is superior, with more ideal economic and environmental protection performance, and has relatively high industrial promotion value.

### DETAILED DESCRIPTION

The method for preparing oxidized lignin polycarboxylate salt described in the present application comprises two processes: oxidation modification and free radical copolymerization. The specific operation is as follows:

(1) adding a lignin into an alkaline solution system to prepare a lignin solution, and adding an oxidant to carry out a oxidation modification treatment at 30° C. to 100° C. for 10 minutes to 120 minutes, introducing carboxyl groups, and obtaining a solution containing oxidized lignin; the amount of the alkaline in the alkaline solution accounts for 10 wt % to 60 wt % of the solid mass of the lignin, the solid mass of the lignin accounts for 5 wt % to 15 wt % of the total amount of the alkaline solution; and the amount of the oxidant added is 20 wt % to 80 wt % of the solid mass of the lignin;

(2) using the oxidized lignin, carboxylic acid based small monomer, and alkenyl polyethylene glycol ether with a mass ratio of 1:(0-20):(0-200) as co-monomers, and adding an initiator for free radical copolymerization reaction in a solution system at 50° C. to 100° C. to obtain the desired oxidized lignin polycarboxylate salt, and the amount of the initiator added accounts for 0.05 wt % to 10 wt % of the total mass of the various monomers.

### Example 1

Firstly, an appropriate amount of sodium hydroxide was gradually added into water and stirred until completely dissolved. Then an appropriate amount of alkaline lignin was weighed and added into the alkaline solution, stirred until dissolved. The lignin accounts for 5% of the total solution mass, and sodium hydroxide accounts for 25% of the solid mass of the lignin; the air inside the solution and reaction vessel was replaced and removed by several passes of nitrogen gas and vacuum pumping. Then, after the solution was heated to stabilize the temperature at 30° C., an appropriate amount of oxygen was introduced, and an oxidation modification reaction was carried out for 60 minutes. By adjusting the solution volume and pressure to make an oxygen content be 50% of the solid mass of lignin, the oxidized lignin was obtained.

Free radical copolymerization reaction was carried out using the above obtained oxidized lignin and allyl polyethylene glycol ether with a molecular weight of 1000 as monomers, and potassium persulfate as initiator. Firstly, allyl polyethylene glycol ether was added into the basic material and stirred to form a homogeneous solution. Then, the oxidized lignin solution and pre-dissolved potassium persulfate solution are added. The mass ratio of allyl polyethylene glycol ether to the oxidized lignin was 2:1, and the mass of potassium persulfate was 6% of the total monomer mass. Then, the temperature was raised for free radical copolymerization reaction, with a reaction temperature of 70° C. and a reaction time of 4 hours, to obtain the oxidized lignin polycarboxylate salt.

### Example 2

Firstly, an appropriate amount of sodium hydroxide was gradually added into water and stirred until completely dissolved. Then an appropriate amount of alkaline lignin was weighed and added into the alkaline solution, stirred until dissolved. The lignin accounts for 5% of the total solution mass, and sodium hydroxide accounts for 25% of the solid mass of the lignin; the air inside the solution and reaction vessel was replaced and removed by several passes of nitrogen gas and vacuum pumping. Then, after the solution was heated to stabilize the temperature at 30° C., an appropriate amount of oxygen was introduced, and an oxidation modification reaction was carried out for 60 minutes. By adjusting the solution volume and pressure to make an oxygen content be 50% of the solid mass of lignin, the oxidized lignin was obtained.

Free radical copolymerization reaction was carried out using the above obtained oxidized lignin and isopentenyl polyethylene glycol ether with a molecular weight of 2400 as monomers, and azodiisobutylamidine hydrochloride as initiator. Firstly, isopentenyl polyethylene glycol ether was added into the basic material and stirred to form a homogeneous solution. Then, the oxidized lignin solution and pre-dissolved azodiisobutylamidine hydrochloride solution were added. The mass ratio of isopentenyl polyethylene glycol ether to the oxidized lignin was 4:1, and the mass of azodiisobutylamidine hydrochloride salt was 3% of the total monomer mass. Then, the temperature was raised for free radical copolymerization reaction, with a reaction temperature of 65° C. and a reaction time of 3.5 hours, to obtain the oxidized lignin polycarboxylate salt.

### Example 3

Firstly, an appropriate amount of sodium hydroxide was gradually added into water and stirred until completely dissolved. Then an appropriate amount of alkaline lignin was weighed and added into the alkaline solution, stirred until dissolved. The lignin accounts for 15% of the total solution mass, and sodium hydroxide accounts for 35% of the solid mass of the lignin; the air inside the solution and reaction vessel was replaced and removed by several passes of nitrogen gas and vacuum pumping. Then, after the solution was heated to stabilize the temperature at 50° C., an appropriate amount of oxygen was introduced, and an oxidation modification reaction was carried out for 30 minutes. By adjusting the solution volume and pressure to make an oxygen content be 20% of the solid mass of lignin, the oxidized lignin was obtained.

Free radical copolymerization reaction was carried out using the above obtained oxidized lignin, methyl allyl polyethylene glycol ether with a molecular weight of 2400 and acrylic acid as monomers, and potassium persulfate as initiator. Firstly, methyl allyl polyethylene glycol ether was added into the basic material and stirred to form a homogeneous solution. Then, the oxidized lignin solution and pre-dissolved potassium persulfate solution were added, and after the temperature was raised to the preset temperature, the acrylic acid solution was added dropwise; the mass ratio of methyl allyl polyethylene glycol ether, oxidized lignin and acrylic acid was 45:3:2, and the mass of potassium persulfate was 2.5% of the total monomer mass. The free radical copolymerization reaction temperature was 70° C., and the acrylic acid dropping time was 2.5 hours. The total reaction time was 3 hours, and the oxidized lignin polycarboxylate salt was obtained.

### Example 4

The preparation method for obtaining oxidized lignin polycarboxylate salt as described in this example is the same as that in Example 3, with the only difference being that the oxidized lignin is mixed with acrylic acid solution and added dropwise.

### Example 5

The preparation method for obtaining oxidized lignin polycarboxylate salt as described in this example is the same as that in Example 2, with the only difference being that the oxidation step of lignin is to introduce hydrogen peroxide for oxidation.

### Example 6

The preparation method for obtaining oxidized lignin polycarboxylate salt as described in this example is the same as that in Example 3, with the only difference being that the alkenyl polyethylene glycol ether was selected as 4-hydroxybutyl vinyl polyethylene glycol ether.

### Example 7

The preparation method for obtaining oxidized lignin polycarboxylate salt as described in this example is the same as that in Example 3, with the only difference being that the carboxylic acid based small monomer was selected as maleic acid.

### Example 8

Firstly, an appropriate amount of sodium hydroxide was gradually added into water and stirred until completely dissolved. Then an appropriate amount of sulfate lignin was weighed and added into the alkaline solution, stirred until dissolved. The lignin accounts for 10% of the total solution mass, and sodium hydroxide accounts for 60% of the solid mass of the lignin; the air inside the solution and reaction vessel was replaced and removed by several passes of nitrogen gas and vacuum pumping. Then, after the solution was heated to stabilize the temperature at 30° C., an appropriate amount of oxygen was introduced, and an oxidation modification reaction was carried out for 120 minutes. By adjusting the solution volume and pressure to make an oxygen content be 80% of the solid mass of lignin, the oxidized lignin was obtained.

Free radical copolymerization reaction was carried out using the above obtained oxidized lignin and methyl allyl polyethylene glycol ether with a molecular weight of 6000 as monomers, and azodiisobutylamidine hydrochloride as initiator. Firstly, methyl allyl polyethylene glycol ether is added into the basic material and stirred to form a homogeneous solution. Then, the oxidized lignin solution and pre-dissolved azodiisobutylamidine hydrochloride were added. The mass ratio of methyl allyl polyethylene glycol ether to the oxidized lignin was 10:1, and the mass of azodiisobutylamidine hydrochloride was 8% of the total monomer mass. Then, the temperature was raised for free radical copolymerization reaction, with a reaction temperature of 80° C. and a reaction time of 4 hours, to obtain the oxidized lignin polycarboxylate salt.

### Example 9

The preparation method for obtaining oxidized lignin polycarboxylate salt as described in this example is the same as that in Example 8, with the only difference being that the alkenyl polyethylene glycol ether is vinyl polyethylene glycol ether.

### Example 10

The preparation method for obtaining oxidized lignin polycarboxylate salt as described in this example is the same as that in Example 8, with the only difference being that the oxidation step is carried out by introducing air for oxidation.

### Example 11

Firstly, an appropriate amount of sodium hydroxide was gradually added into water and stirred until completely dissolved. Then an appropriate amount of lignin sulfate was weighed and added into the alkaline solution, stirred until dissolved. The lignin accounts for 5% of the total solution mass, and sodium hydroxide accounts for 45% of the solid mass of the lignin; the air inside the solution and reaction vessel was replaced and removed by several passes of nitrogen gas and vacuum pumping. Then, after the solution was heated to stabilize the temperature at 100° C., an appropriate amount of oxygen was introduced, and an oxidation modification reaction was carried out for 10 minutes. By adjusting the solution volume and pressure to make an oxygen content be 20% of the solid mass of lignin, the oxidized lignin was obtained.

Free radical copolymerization reaction was carried out using the above obtained oxidized lignin, allyl polyethylene glycol ether with a molecular weight of 500 and maleic acid as monomers, and sodium persulfate as initiator. Firstly, allyl polyethylene glycol ether and maleic acid were added into the basic material and stirred to form a homogeneous solution. Then, the oxidized lignin solution and pre-dissolved sodium persulfate solution were added. The mass ratio of allyl polyethylene glycol ether, maleic acid, and oxidized lignin was 10:3:2, and the mass of sodium persulfate was 10% of the total monomer mass. Then, the temperature was raised for free radical copolymerization reaction, with a reaction temperature of 90° C. and a reaction time of 4 hours, to obtain the oxidized lignin polycarboxylate salt.

### Example 12

The preparation method for obtaining oxidized lignin polycarboxylate salt as described in this example is the same as that in Example 10, with the only difference being that the oxidation step involves introducing ozone for oxidation.

### Comparative Example 1

Free radical copolymerization reaction was carried out using methyl allyl polyethylene glycol ether with a molecular weight of 2400 and acrylic acid as monomers, potassium persulfate as initiator, and sodium hypophosphite as chain transfer agent. Firstly, methyl allyl polyethylene glycol ether was added into the basic material and stirred to form a homogeneous solution. Then, pre-dissolved potassium persulfate solution and sodium hypophosphite solution were added, and after the temperature was raised to the preset temperature, the acrylic acid solution was added dropwise; the mass ratio of methyl allyl polyethylene glycol ether to acrylic acid was 9:1, the mass of potassium persulfate was 2.5% of the total monomer mass, and the mass of sodium hypophosphite is 1% of the total monomer mass. The reaction temperature was 70° C., and the dropping time of acrylic acid was 2.5 hours. The total reaction time was 3 hours, and the polycarboxylate salt is obtained.

### Comparative Example 2

An appropriate amount of alkaline lignin was weighed and added into water and stirred for keeping the suspension evenly dispersed. Sulfuric acid was added to adjust the pH to 3-4. The lignin accounts for 5% of the total solution mass, and the air inside the solution and reaction vessel was replaced and removed by several passes of nitrogen gas and vacuum pumping; then, after the solution was heated to stabilize the temperature at 30° C., an appropriate amount of oxygen was introduced, and an oxidation modification reaction was carried out for 60 minutes. By adjusting the solution volume and pressure to make an oxygen content be 50% of the solid mass of lignin, the oxidized lignin is obtained.

Free radical copolymerization reaction was carried out using the above obtained oxidized lignin and allyl polyethylene glycol ether with a molecular weight of 1000 as monomers, and potassium persulfate as initiator. Firstly, allyl polyethylene glycol ether was added into the basic material and stirred to form a homogeneous solution. Then, the oxidized lignin solution and pre-dissolved potassium persulfate solution were added. The mass ratio of allyl polyethylene glycol ether to the oxidized lignin was 2:1, and the mass of potassium persulfate was 6% of the total monomer mass. Then, the temperature was raised for free radical copolymerization reaction, with a reaction temperature of 70° C. and a reaction time of 4 hours, to obtain the oxidized lignin polycarboxylate salt.

### Comparative Example 3

An appropriate amount of alkaline lignin was weighed and added into water and stirred for keeping the suspension evenly dispersed. Sulfuric acid was added to adjust the pH to 3-4, and then an appropriate amount of pre-dissolved potassium permanganate solution was added. The lignin accounts for 5% of the total mass of the suspension, and potassium permanganate accounts for 50% of the mass of lignin; the air inside the solution and reaction vessel was replaced and removed by several passes of nitrogen gas and vacuum pumping; then, after the system was heated to 80° C., the materials reacted for 60 minutes to obtain the oxidized lignin.

Free radical copolymerization reaction was carried out using the above obtained oxidized lignin and allyl polyethylene glycol ether with a molecular weight of 1000 as monomers, and potassium persulfate as initiator. Firstly, allyl polyethylene glycol ether was added into the basic material and stirred to form a homogeneous solution. Then, the oxidized lignin solution and pre-dissolved potassium persulfate solution were added. The mass ratio of allyl polyethylene glycol ether to the oxidized lignin was 2:1, and the mass of potassium persulfate was 6% of the total monomer mass. Then, the temperature was raised for free radical copolymerization reaction, with a reaction temperature of 70° C. and a reaction time of 4 hours, to obtain the oxidized lignin polycarboxylate salt.

### Experimental Example

According to GB8076-2008 “Concrete Admixtures”, a application performance tests on the samples of Examples 1˜4 and Comparative examples 1-3 was carried out. The cement used is P.O 42.5, the concrete mix ratio is C30, and the water reducer mixing dosage is based on the weight of cement after deducting the water brought in from the admixture.

The ingredients of the concrete comprise: 200 parts by weight of cement, 100 parts by weight of fly ash, 80 parts by weight of slag, 796 parts by weight of sand, 1054 parts by weight of stone, and 170 parts by weight of water.

The test results of each sample are shown in Table 1 below.

TABLE 1
Application performance tests of water reducers

| | | Mixing | Extensibility/mm | | | Gas | Strength/MPa | | |
|---|---|---|---|---|---|---|---|---|---|
| Sample | | Dosage/% | 0 min | 1 h | 2 h | content/% | 3 d | 7 d | 28 d |
| Example 1 | oxidized lignin | 0.4 | 420 | 360 | 250 | 5.8 | 10.3 | 18.4 | 24.5 |
| | oxidized lignin | 0.2 | 540 | 520 | 470 | 1.6 | 14.2 | 23.3 | 30.9 |
| | polycarboxylate | | | | | | | | |
| | salt | | | | | | | | |
| Example 2 | oxidized lignin | 0.2 | 520 | 480 | 420 | 1.7 | 13.6 | 22.8 | 30.6 |
| | polycarboxylate | | | | | | | | |
| | salt | | | | | | | | |
| Example 3 | oxidized lignin | 0.4 | 430 | 380 | 290 | 5.2 | 11.7 | 19.2 | 25.3 |
| | oxidized lignin | 0.2 | 550 | 490 | 430 | 1.5 | 14.3 | 23.9 | 31.7 |
| | polycarboxylate | | | | | | | | |
| | salt | | | | | | | | |
| Example 4 | oxidized lignin | 0.2 | 540 | 500 | 450 | 1.6 | 13.8 | 24.2 | 30.8 |
| | polycarboxylate | | | | | | | | |
| | salt | | | | | | | | |
| Comparative | polycarboxylate | 0.2 | 550 | 480 | 380 | 1.4 | 14.2 | 23.6 | 31.2 |
| example 1 | salt | | | | | | | | |
| Comparative | oxidized lignin | 0.4 | 280 | / | / | 8.6 | 8.6 | 15.8 | 21.8 |
| example 2 | oxidized lignin | 0.2 | 240 | / | / | 3.2 | 9.8 | 16.3 | 22.5 |
| | polycarboxylate | | | | | | | | |
| | salt | | | | | | | | |
| Comparative | oxidized lignin | 0.4 | 320 | / | / | 10.3 | 7.3 | 13.2 | 20.7 |
| example 3 | oxidized lignin | 0.2 | 270 | / | / | 4.7 | 8.9 | 14.6 | 21.1 |
| | polycarboxylate | | | | | | | | |
| | salt | | | | | | | | |

From the data in Table 1 above, it can be seen that the water reduction rate of non-copolymerized oxidized lignin is relatively low, and the air entrainment and delayed coagulation were obvious, which affects the strength of concrete. Through the data in Examples 1˜4 and in Comparative example 1, it can be found that after replacing carboxylic acid based small monomer completely or partially with the oxidized lignin, the water reduction rate, air entrainment, and strength of polycarboxylate water reducer are not significantly affected, and the slump retention ability of polycarboxylate water reducer can be significantly improved.

Therefore, the present application provides a practical and feasible method for preparing low-cost oxidized lignin polycarboxylate salt water reducers, which is suitable for large-scale industrial promotion and application.

Obviously, the above examples are merely examples made for clear description, rather limiting the implementations. For those of ordinary skill in the art, other different forms of variations or modifications can also be made on the basis of the above-mentioned description. All embodiments are not necessary to be and cannot be exhaustively listed herein. In addition, obvious variations or modifications derived therefrom all fall within the scope of protection of the present invention.

1. A method for preparing oxidized lignin polycarboxylate salt, wherein the method comprises the following steps:
(1) adding a lignin into an alkaline solution system to prepare a lignin solution, and adding an oxidant to carry out an oxidation modification treatment to the lignin to obtain a solution containing oxidized lignin;
(2) using the oxidized lignin, a carboxylic acid based small monomer, and an alkenyl polyethylene glycol ether as co-monomers, and adding an initiator for free radical copolymerization reaction in a solution system to obtain the desired oxidized lignin polycarboxylate salt.

2. The method for preparing oxidized lignin polycarboxylate salt of claim 1, wherein, in step (1), the lignin comprises one of or a mixture of more of alkali lignin, sulfate lignin, lignin sulfonate salt and organic solvent lignin.

3. The method for preparing oxidized lignin polycarboxylate salt of claim 1, wherein, in step (1), an alkaline substance in the alkaline solution comprises one of or a mixture of more of alkali metal or alkali earth metal hydroxides, and alkali metal or alkali earth metal salts.

4. The method for preparing oxidized lignin polycarboxylate salt of claim 1, wherein, in step (1), the oxidant comprises one of or a mixture of more of peroxides, molecular oxygen, air or ozone.

5. The method for preparing oxidized lignin polycarboxylate salt of claim 1, wherein, in step (2), the mass ratio of the oxidized lignin, carboxylic acid based small monomer, and alkenyl polyethylene glycol ether is 1:(0-20):(0-200).

6. The method for preparing oxidized lignin polycarboxylate salt of claim 1, wherein, in step (2), the initiator comprises a persulfate salt and a water-soluble azo initiator.

7. The method for preparing oxidized lignin polycarboxylate salt of claim 1, wherein,
in step (1), the oxidation modification treatment step is carried out at a temperature ranging from 30° C. to 100° C. for a reaction time period ranging from 10 minutes to 120 minutes; and/or,
in step (2), the free radical copolymerization reaction is carried out at a temperature ranging from 50° C. to 100° C.

8. The method for preparing oxidized lignin polycarboxylate salt of claim 1, wherein, in step (2), the mode for feeding respective raw materials comprises:
carrying out a polymerization reaction directly based on the solution system containing the oxidized lignin obtained in step (1) as the basic material, adding the initiator directly into the basic material, and adding a carboxylic acid based small monomer and alkenyl polyethylene glycol ether monomer to carry out a copolymerization reaction directly; or,
adding the solution containing the oxidized lignin, an alkenyl polyethylene glycol ether, and an initiator into the basic material, and preparing and forming a solution from the carboxylic acid based small monomer and dropping the solution into the reaction vessel; or,
adding the alkenyl polyethylene glycol ether and the initiator into the basic material, and mixing the solution containing the oxidized lignin with the carboxylic acid based small monomer to prepare a solution and dropping the solution into the reaction vessel for reaction; or
adding the initiator into the basic material directly, mixing the solution containing the oxidized lignin with the carboxylic acid based small monomer to form a solution, and preparing and forming a solution from the alkenyl polyethylene glycol ether, and dropping them respectively into the reaction vessel for reaction.

9. An oxidized lignin polycarboxylate salt, wherein the oxidized lignin polycarboxylate salt is prepared by the method of claim 1.

10. A method for preparing high-efficiency water reducer, comprising using the oxidized lignin polycarboxylate of claim 9 in concrete for water reducing.

11. The method for preparing oxidized lignin polycarboxylate salt of claim 2, wherein the solid mass of the lignin accounts for 5 wt % to 15 wt % of the total amount of the alkaline solution.

12. The method for preparing oxidized lignin polycarboxylate salt of claim 3, wherein the amount of the alkaline substance in the alkaline solution accounts for 10 wt % to 60 wt % of the solid mass of the lignin.

13. The method for preparing oxidized lignin polycarboxylate salt of claim 4, wherein the amount of the oxidant added is 20 wt % to 80 wt % of the solid mass of the lignin.

14. The method for preparing oxidized lignin polycarboxylate salt of claim 5, wherein the carboxylic acid based small monomer comprise one of or a mixture of more of acrylic acid, methacrylic acid, maleic acid, or itaconic acid.

15. The method for preparing oxidized lignin polycarboxylate salt of claim 5, wherein the alkenyl polyethylene glycol ether comprises one of or a mixture of more of allyl polyethylene glycol ether, methyl allyl polyethylene glycol ether, isopentenyl polyethylene glycol ether, vinyl polyethylene glycol ether, and 4-hydroxybutyl vinyl polyethylene glycol ether.

16. The method for preparing oxidized lignin polycarboxylate salt of claim 6, wherein the amount of the initiator added accounts for 0.05 wt % to 10 wt % of the total mass of the various monomers.

17. The method for preparing oxidized lignin polycarboxylate salt of claim 8, wherein controlling the dropping time of the carboxylic acid based small monomer solution to be 2 hours to 4 hours.

18. The method for preparing oxidized lignin polycarboxylate salt of claim 8, wherein controlling the dropping time of the solution of the carboxylic acid based small monomer-oxidized lignin to be 2 hours to 4 hours.

19. The method for preparing oxidized lignin polycarboxylate salt of claim 8, wherein controlling the dropping time of the solution of the carboxylic acid based small monomer-oxidized lignin to be 2 hours to 4 hours, and the dropping time for the solution of the alkenyl polyethylene glycol ether to be 2.5 hours to 4.5 hours.

20. The method for preparing oxidized lignin polycarboxylate salt of claim 2, wherein, in step (1), an alkaline substance in the alkaline solution comprises one of or a mixture of more of alkali metal or alkali earth metal hydroxides, and alkali metal or alkali earth metal salts.
